(19) United States
(12) Patent Application Publication
(10) Pub. No.: US 2017/0253190 A1
(43) Pub. Date: Sep. 7, 2017

(54) Entertainment Partition System and Method for a Luxury Vehicle

(71) Applicant: Frank Hodges, Corona, CA (US)

(72) Inventor: Frank Hodges, Corona, CA (US)

(21) Appl. No.: 15/063,398

(22) Filed: Mar. 7, 2016

(51) Int. Cl. B60R 11/02; B60N 3/06

(52) U.S. Cl. CPC B60R 11/0235; B60N 3/06; B60Y 2304/00; B60R 2011/0003

(57) ABSTRACT

The present invention relates to vehicle partitions for privacy from a driver. In particular, the present invention relates to a divider that can be installed in current model SUVs and sedans without expensive modification to the body of the vehicle and taking advantage of the placement of air conditioning controls that are already installed for rear passengers.

### CROSS-REFERENCE TO RELATED APPLICATION

n/a

### FIELD OF THE INVENTION

The present invention is in the field of mobile entertainment partition systems and methods of manufacturing for luxury executive vehicles.

### BACKGROUND

Many present day in-vehicle entertainment systems include an in-dash mounted radio frequency (RF) receiver, CD/DVD player, and a universal serial bus (USB) port for the system to download program source data from a thumb drive or similar memory device. A vehicle passenger may use a portable electronic device (PED) such as a smart phone, tablet, or media player (e.g. an I-POD®) to access program source data previously stored on the PED. Entertainment systems for automobiles are well known. As such, many advances have been made in the development of entertainment systems that make the otherwise tedious task of riding in an automobile almost bearable. In addition to the development of overhead systems pioneered by the present inventor, a variety of systems and techniques for integrating entertainment systems within an automobile has been developed.

For example, headrest entertainment systems have been developed and allow multiple individuals to view a variety of different video sources within the same vehicle. However, some automobiles are not suited for the utilization of headrest entertainment systems and, therefore, are unable to take advantage of this advancement in technology. Similarly, only larger vehicles can take advantage of the overhead systems commonly found in automobiles. None of these systems is suitable for luxury travel.

In many taxi cabs, there is a partition between the driver and the back seat passengers. While for taxi cabs drivers this partition exists for safety reasons, in high end luxury vehicles, this partition can act as a sound barrier between the driver and the back seat passengers. When one is having confidential conversations and wants to keep the driver from overhearing them, a partition can be quite useful.

Combining the benefits of an entertainment system with a partition to create an entertainment partition system makes sense in a luxury vehicle. For instance, with an entertainment partition system, there is now no need for a headrest entertainment system. A partition can come equipped with monitors for surveillance, TV watching, video games, and other activities. An entertainment partition system is definitely a value add for luxury vehicles, which are already outfitted with features that rival that of first class accommodations on airplanes. In many luxury vehicles, the partition is one component of the entire in-vehicle entertainment system. Such systems come with an in-dash mounted radio frequency (RF) receiver, CD/DVD player, and a universal serial bus (USB) port for the system to download program source data from a thumb drive or similar memory device. A vehicle passenger may use a portable electronic device (PED) such as a smart phone, tablet, or media player (e.g. an I-POD®) to access program source data previously stored on the PED.

While a partition is clearly an improvement to the features of an already impressive luxury vehicle, it should not impact the comfort of back seat passengers. In many luxury vehicles, such as the Cadillac Escalade, the air conditioner console that controls the temperature for back seat passengers is located behind the middle of the driver and passenger seats. If a partition descends from the roof of the vehicle at a 90 degree angle, it will block the air conditioner console from the back seat passengers. In addition, if the partition comes straight down from to the top of the bottom of a vehicle, this will limit the legroom of the back seat passengers. If a partition originates as either a single panel from one side of the vehicle or as split panels from both sides of the vehicle, and moves straight across towards the console, this will also limit the legroom of the back seat passengers. Back seat passengers with limited legroom do not connote the idea of luxury.

With this in mind, an alternative that does not limit the legroom of back seat passengers, making travel more comfortable, is needed. The present invention attempts to add to the choices consumers have by providing a solution to this problem.

Although various improvements are known to the art, all, or almost all of them suffer from one or more than one disadvantage. Therefore, there is a need to provide an improved entertainment partition system and method of installation in luxury vehicles.

### RELEVANT ART REFERENCES

U.S. Pat. No. 5,918,183 issued to Jansky et al., discloses a concealed mobile communications system.

U.S. Pat. No. 7,163,251 issued to Sitzler et al., discloses a seat back storage system for a vehicle entertainment system.

U.S. Pat. No. 7,604,291 issued to Vitito discloses a vehicle entertainment system incorporated within the armrest/console of a vehicle with a swivel monitor mounting structure.

U.S. patent application Ser. No. 10/225,674 disclosed by Imamura et al., discloses an in-vehicle monitor support structure.

U.S. patent application Ser. No. 11/874,684 disclosed by Revelino et al., discloses a flat screen television bracket for a vehicle.

U.S. patent application Ser. No. 11/571,223 disclosed by Handa discloses a panel driven apparatus.

U.S. patent application Ser. No. 13/652,566 disclosed by Kelly discloses an in-vehicle entertainment system for providing program source data to a portable electronic device.

U.S. Pat. No. 5,246,261 issued to McCormack, discloses a safety partition for motor vehicles.

U.S. Pat. No. 4,621,856 issued to McKenzie, discloses a mountable and demountable partition structure for motor vehicles.

U.S. Pat. No. 9,033,389 issued to Setina, discloses a partition providing increased legroom.

These publications and all other referenced patents are incorporated herein by reference in their entirety. Furthermore, where a definition or use of a term in a reference, which is an incorporated reference here, is inconsistent or contrary to the definition of that term provided herein the definition of the term provided herein applies and the definition of that term in the reference does not apply.

The relevant art references that relate to entertainment systems all suffer from one or more disadvantage that make them different than the present invention. U.S. Pat. No. 5,918,183 is meant for retrieving stolen vehicles, not as a partition. U.S. Pat. No. 7,163,251 is designed for a seat back, not the large screen that a luxury vehicle's entertainment system can accommodate. U.S. Pat. No. 7,604,291 is an entertainment system in an armrest, which can be incorporated into many standard vehicles. The present invention can accommodate a large screen so that all the back seat passengers can view it with ease. U.S. Pat. No. 7,604,291 has a small screen attached to the armrest, which would be difficult for some back seat passengers to view. U.S. patent application Ser. No. 10/225,674 discloses an entertainment system with a small screen like the one found in U.S. Pat. No. 7,604,291. Again, the small size of screen could potentially be sufficient in a standard size car, but certainly not a larger luxury vehicle that can fit more passengers. U.S. patent application Ser. No. 11/874,684 is a bracket than can support a large screen, but the present invention allows the screen to be hidden from view of the back seat passengers. U.S. patent application Ser. No. 11/874,684 does not have this capability; it can only be raised and lowered. U.S. patent application Ser. No. 11/571,223 is not meant to be mounted in a vehicle, so it is unlike the present invention in that respect. One of the components of U.S. patent application Ser. No. 13/652,566 is a portable electronic device, which is outside the scope of the present invention. The present invention is hardly portable; it comprises primarily of a structure that can accommodate a large screen.

There are many vehicle partition patents and patent applications that exist in the art, but all have some disadvantage over the present invention. U.S. Pat. No. 5,246,261 is a vehicle partition that offers additional storage space to back seat passengers, but the partition does offer additional legroom. U.S. Pat. No. 4,621,856 is a removable partition whose main purpose is to serve as a thermal barrier between the front seat and the cargo storage area in the back of carbo vans. Obviously, back seat passenger legroom is not a concern. While one of the stated functions of U.S. Pat. No. 9,033,389 is to provide additional legroom, this partition is fixed; it cannot be deployed and withdrawn automatically. In fact, none of partition patents listed in the relevant art references can be deployed and withdrawn, with the exception of U.S. Pat. No. 4,621,856, which must be manually removed.

### SUMMARY OF THE INVENTION

In view of the shortcomings of the prior art, it is the object of this invention to provide an entertainment partition system in a vehicle without completely customizing a mobile movie theater. The entertainment partition system can be used for watching movies, video surveillance, conference calling and other applications. There are limitations to the degree of modification that a vehicle can accommodate, which is why the size of the vehicle is of significance. Ideally, one would not want modifications to be obvious from the outside of the vehicle. For the present invention, the average observer most likely will not notice modifications in the length and width of the vehicle. However, the vehicle's height is modified to accommodate the present invention.

It is further an object of the invention that the invention not block back seat passengers from accessing the air conditioner console once the invention has been deployed.

It is further an object of the invention that the bottom portion of the invention angle away from the back seat passenger at a non-90 degree angle to afford the back seat passenger more legroom and a more comfortable ride.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments and in the appended claims.

### BRIEF DESCRIPTION OF THE DRAWINGS

FIG. 1 shows a preferred embodiment of an entertainment partition system, installable in a sport utility vehicle (SUV) and as seen by back seat passengers.

FIG. 2 shows a preferred embodiment of an entertainment partition system as seen from the front passenger side of the vehicle.

FIG. 3 shows a preferred embodiment of an entertainment partition system as seen from the driver side of the vehicle.

FIG. 4 shows a preferred embodiment of an entertainment partition system as seen from the top and front portion of the vehicle.

FIG. 5 shows a preferred embodiment of an entertainment partition system as seen from the top and rear portion of the vehicle.

FIG. 6 shows a preferred embodiment of an entertainment partition system as seen from the driver and front passenger side of the vehicle.

FIG. 7 shows a preferred embodiment of an entertainment partition system for installation into an SUV as seen from a frontal perspective view.

### DETAILED DESCRIPTION OF THE EMBODIMENTS

Referring now to the drawings wherein the showings are for purposes of illustrating a preferred embodiment of the present invention and not for purposes of limiting the same.

A first embodiment of the invention is a partition 1 adapted for insertion into a vehicle. The partition 1 may be made of various materials comprising metal, polymer, and wood to achieve a strong, light weight, and sturdy support for a monitor in a vehicle. The dimensions are given with respect to accommodate two 25-30 inch TV monitors 9 in a Cadillac Escalade®.

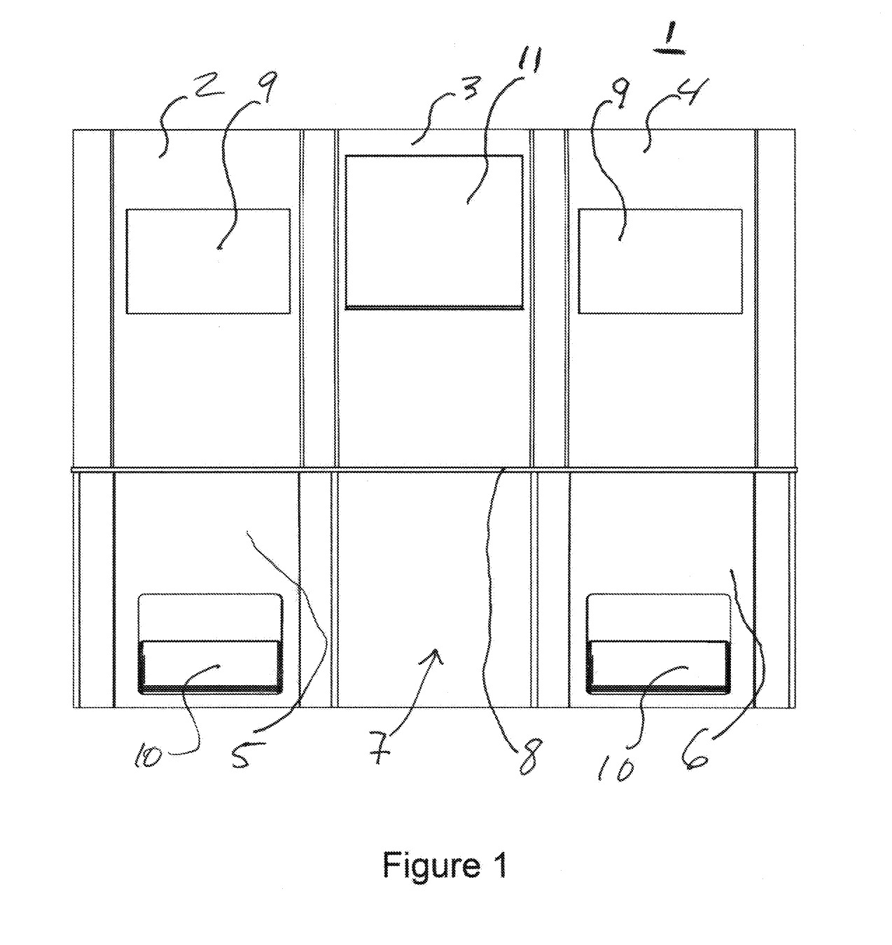

FIG. 1 shows the partition 1 as seen if a vehicle's back seat passengers are looking directly at it. As the partition 1 is deployed, either from the top to the bottom of the vehicle or from one side to the other side of the vehicle, there are six distinct portions. The left top portion 2 is located behind the driver and houses one TV monitor 9. The middle top portion 3 houses a window 11 that allows the front seat passengers to see the back of the vehicle. The right top portion 4 is located behind the front passenger and houses one TV monitor 9. The left bottom portion 5 is located behind the driver and has one footrest 10. The right bottom portion 6 is located behind the front passenger and houses a footrest 10. The air conditioner console space 7 is an empty space that can accommodate an air conditioner console operable by back seat passengers, standard in SUVs such as the Cadillac Escalade. The divider 8 separates the left top portion 2, middle top portion 3, and right top portion 4 from the left bottom portion 5, air conditioner console space 7, and right bottom portion 6. To accommodate the partition 1, the back seats behind the driver and front passenger seats must be moved back two to twelve inches. In the fully deployed position, the partition 1 blocks off communication between the back seat and front seat passengers. The back seat passengers also have access to the TV monitors 9. The window 11 can be lowered so that the front seat and back seat passengers can communicate with each other as in a taxi cab. When the partition 1 is not deployed, or in the retracted state, there is open space between the back seat and front seat passengers, allowing the back seat and front seat passengers to communicate freely without physical obstruction. The partition 1 is operable via an electric motor to be deployed and retracted depending on a back seat passenger's preference. The back seat passenger also controls the deployment and retraction of the footrest 10. The window 10 can be transparent or any other opaque material. While in a preferred embodiment the window moves in a vertical up and down motion, it is possible to have the window 10 move in a sliding manner to the left or right or both.

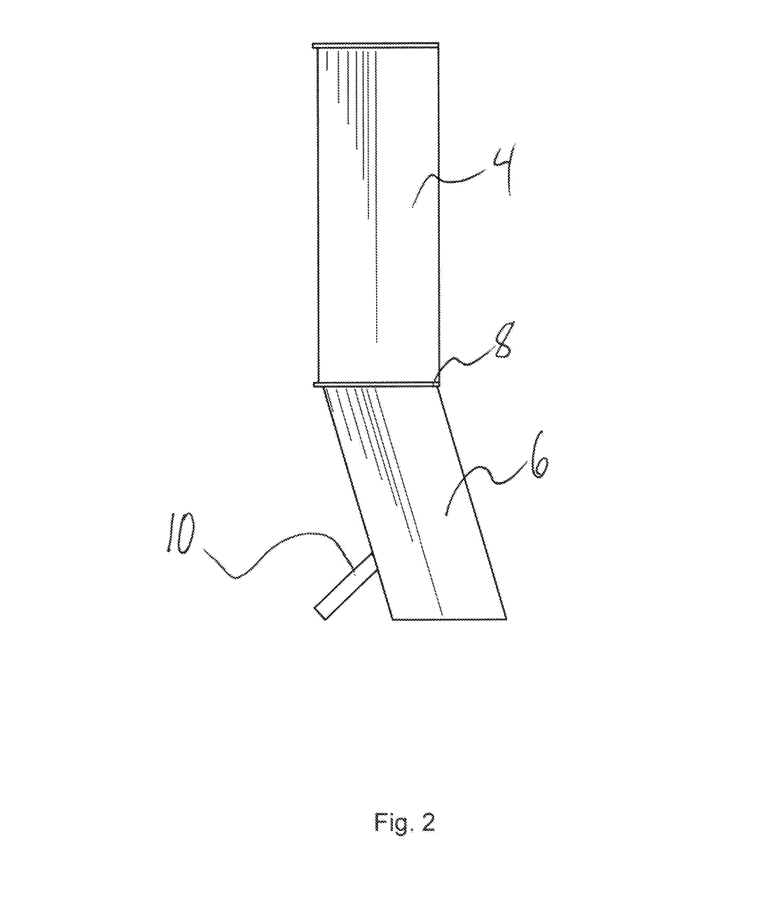

FIG. 2 shows a preferred embodiment of the partition 1 as seen from the front passenger side of the vehicle. Once fully deployed, the right top portion 4 and the right bottom portion 6 create a non-90 degree angle at the divider 8. In a preferred embodiment, the angle from the divider 8 serving as the vertex can range from 10 degrees to 70 degrees as measured from the vertical plane towards the driver. However, it should be noted that the divider 8 vertex angle could also extend towards the passenger portion to serve as an integrated footrest and even provide hidden storage for a rear seat passenger.

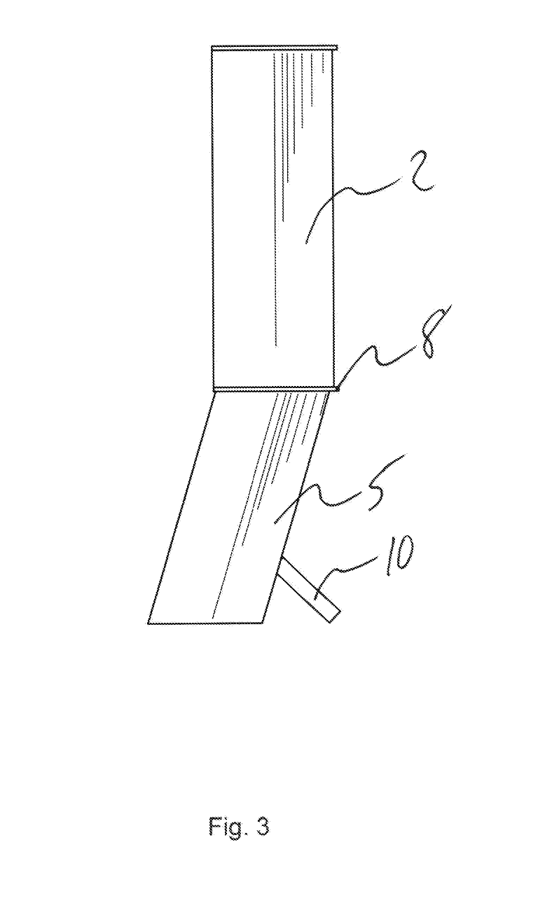

FIG. 3 shows a preferred embodiment of the partition 1 as seen from the driver side of the vehicle. Once deployed, the left top portion 2 and the left bottom portion 5 form a non-90 degree angle at the divider 8. The angle between the left top portion 2 and the left bottom portion 5 ranges from 10 degrees to 70 degrees as measured from the vertical plane.

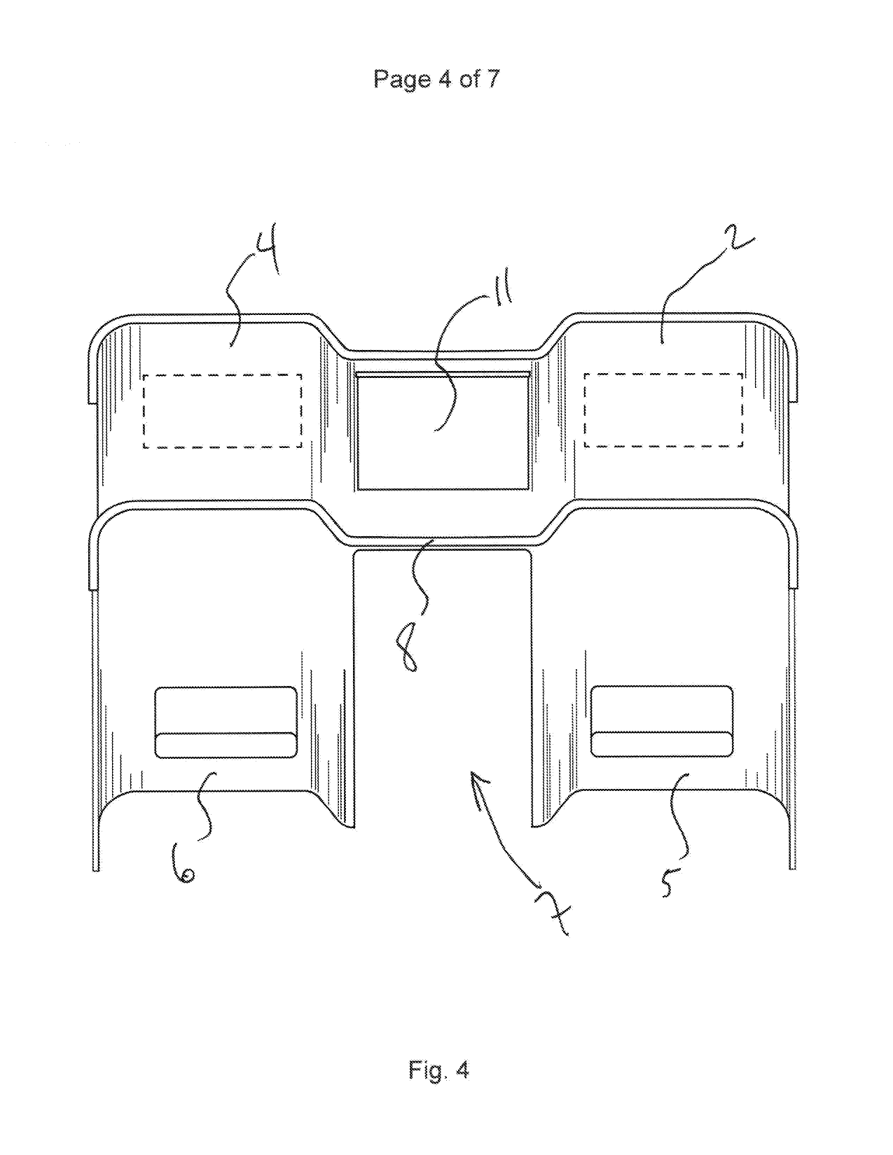

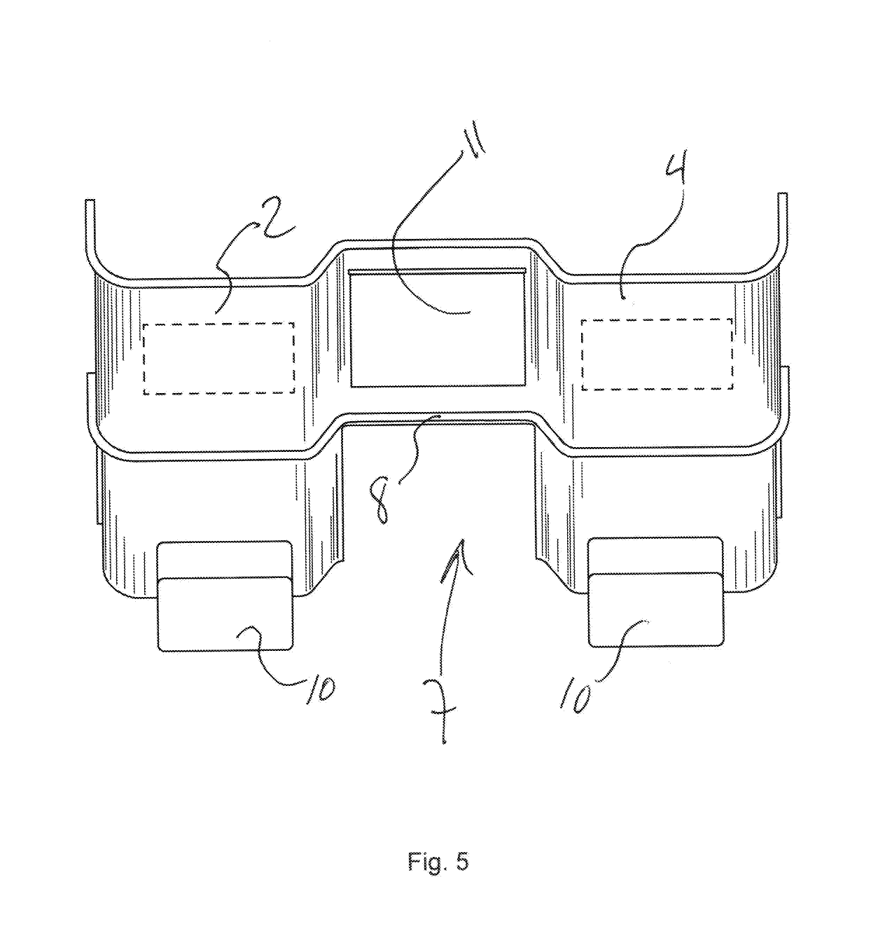

FIGS. 4 and 5 show a preferred embodiment of the partition 1 as seen from the top of the vehicle. FIG. 4 is from the perspective of someone hovering over the front of the vehicle with his head pointing toward the rear of the vehicle. FIG. 5 is from the perspective of someone hovering over the rear of the vehicle with his head pointing toward the front of the vehicle. In FIG. 4, the footsteps are retracted, while in FIG. 5, the footsteps are deployed.

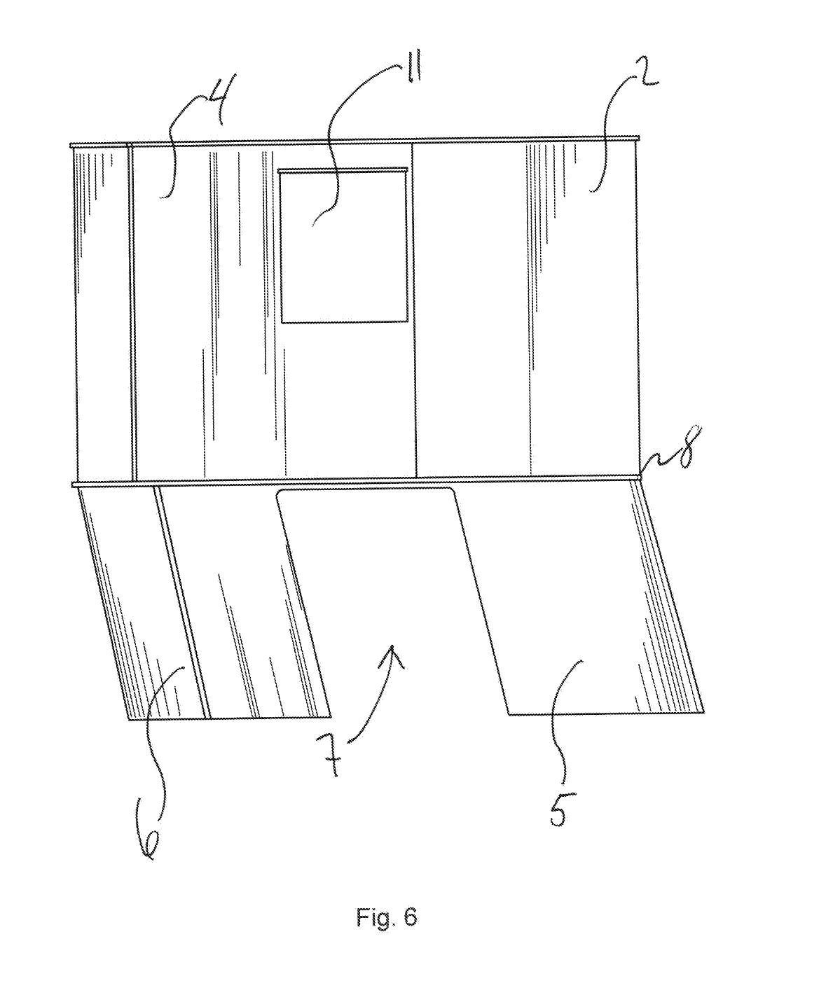

FIG. 6 is a preferred embodiment of the partition 1 as seen from the front of the vehicle as if one is standing and facing the vehicle. The TV monitors 9 and footrests 10 are not visible, since they are only visible and accessible by the back seat passengers. Those in the driver and front passenger seats can communicate verbally with the back seat passengers when the window 11 is in the open position. When the window 11 is closed, the front seat passenger and driver are restricted in their interaction with the back seat passengers, affording the back seat passengers the luxury of privacy.

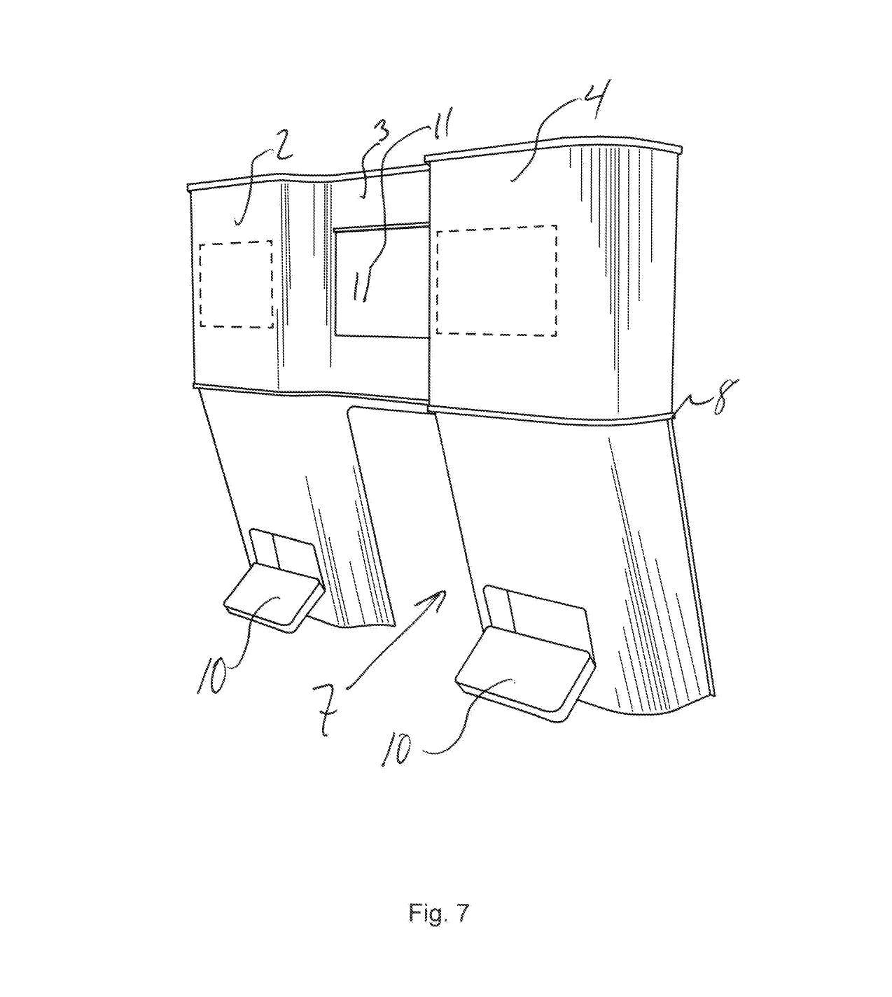

FIG. 7 is a preferred embodiment of the partition 1 from a frontal view. As the partition 1 is deployed, both the left bottom portion 5 and right bottom portion 6 bend from 10 degrees to 70 degrees towards the front of the vehicle. If the left bottom portion 5 and right bottom portion 6 came straight down upon deployment of the partition 1, the back seat passengers would not have nearly as much legroom as possible. The angling of the left bottom portion 5 and right bottom portion 6 allows the back seat passengers to have extra legroom and a more comfortable ride.

The foregoing description is, at present, considered to be the preferred embodiment of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects. Additional modifications and improvements of the present invention may also be apparent to those skilled in the art. Thus, the particular combination of parts described and illustrated herein is intended to represent only one embodiment of the invention, and is not intended to serve as limitations of alternative devices within the spirit and scope of the invention.

What is claimed is:

1. An entertainment partition system for a motor vehicle comprising: a left top portion 2, a middle top portion 3, a right top portion 4, a left bottom portion 5, an air conditioner console space 7, a divider 8, and a right bottom portion 6; wherein the left top portion 2 and right top portion 4 house TV monitors 9; wherein the left bottom portion 5 and right bottom portion 6 house a footrest 10; and wherein the middle top portion 3 houses a window 11.

2. The entertainment partition system of claim 1 wherein the divider 8 separates the left top portion 2, the middle top portion 3, and the right top portion 4 from the left bottom portion 5, the air conditioner console space 7 and the right bottom portion 6.

3. The entertainment partition system of claim 1 wherein the partition 1 is deployed and retracted from the top of the vehicle to the bottom of the vehicle.

4. The entertainment partition system of claim 1 wherein the partition 1 is deployed and retracted from one side of the vehicle to the other side of the vehicle.

5. The entertainment system of claim 1 wherein the air conditioner console space 7 is large enough to accommodate the air conditioner console so that back seat passengers can access the air conditioner console when the partition 1 is deployed.

6. The entertainment partition system of claim 1 wherein the partition 1 can be deployed to a closed position to form a physical and sound barrier between the driver and front seat passenger and the back seat passengers, and retracted to an open position to allow free communication between the driver and front seat passenger and the back seat passengers.

7. The entertainment partition system of claim 1 wherein the left bottom portion 5 and right bottom portion 6 bend at a non-90 degree angle towards the front of a motor vehicle.

8. The entertainment partition system of claim 7 wherein the non-90 degree angle ranges between 10 degrees and 70 degrees as measured from the vertical plane.

9. The entertainment partition system of claim 1 wherein the back seats of the motor vehicle are moved backwards to accommodate the partition 1.

10. The entertainment partition system of claim 9 wherein the back seats of the motor vehicle are moved backwards 2-12 inches to accommodate the partition 1.

11. The entertainment partition system of claim 1 wherein the partition 1 is comprised of metal, polymer, ceramic, wood, or combinations thereof.

12. An entertainment partition system for a motor vehicle comprising: a left top portion 2, a middle top portion 3, a right top portion 4, a left bottom portion 5, an air conditioner console space 7, a divider 8, and a right bottom portion 6.

13. The entertainment partition system of claim 12 wherein the divider 8 separates the left top portion 2, the middle top portion 3, and the right top portion 4 from the left bottom portion 5, the air conditioner console space 7 and the right bottom portion 6.

14. The entertainment partition system of claim 12 wherein the left bottom portion 5 and the right bottom portion 6 bend at a non 90-degree angle toward the front of the motor vehicle.

15. The entertainment partition system of claim 14 wherein the non 90-degree angle ranges between 10 degrees and 70 degrees as measured from the vertical plane.

16. The entertainment partition system of claim 12 wherein the back seats of the motor vehicle are moved backwards 2-12 inches to accommodate the partition 1.
